(19) United States
(12) Patent Application Publication
(10) Pub. No.: US 2004/0102860 A1
(43) Pub. Date: May 27, 2004

(54) Device of playing songs and displaying lyrics thereof and method therefor

(75) Inventors: Cheng-Shing Lai, Taipei Hsieng (TW); Bang-Hua Mao, Nanking (CN)

Correspondence Address: BACON & THOMAS, PLLC, 625 SLATERS LANE, FOURTH FLOOR, ALEXANDRIA, VA, 22314

(73) Assignee: Invectec Appliances Corp., Taipei Hsieng (TW)

(21) Appl. No.: 10/304,688

(22) Filed: Nov. 27, 2002

(51) Int. Cl. G06F 17/00; H04R 5/02

(52) U.S. Cl. 700/94; 381/306

(57) ABSTRACT

The invention is to provide a device of playing songs and displaying lyrics thereof and a method therefor, which are able to activate a CPU in the device to command a decoder to decompress the song file stored in a storage element; output the song file as uncompressed digital sounds from an audio output element in the device; activate the CPU to fetch a image file stored in the storage element corresponding to the song file; and output the image file as a digital image from a display element of the device. Hence, a user not only can hear a song playing from the device but also can see lyrics of the song shown on the display element at the same time.

### FIELD OF THE INVENTION

The present invention relates to devices of playing Moving Picture Exports Group (MPEG) layer 3 (MP3) songs and more particularly to such a device capable of playing a MP3 song and displaying lyrics thereof on a display of the device at the same time and a method therefor.

### BACKGROUND OF THE INVENTION

Conventionally, a device capable of playing MP3 songs (e.g., commercially called player) is shown in FIG. 1. The player comprises a housing 1, a display 10 on a front surface, a plurality of buttons 12 below the display 10, a sound source (not shown) on the housing 1, a pair of audio output elements 2 coupled to the sound source, and control circuit having required elements for controlling a playing of the player. When the player is activated, titles of a plurality of song files (e.g., if, snowbird, top of the world) are shown on the display 10. A user can press one of the buttons 12 to choose a desired song. Once chosen, the song file is processed to convert into audio signals by the player. Eventually, the audio signals are converted into digital sounds by the audio output elements 2 for output.

However, the prior art player suffered from a disadvantage. For example, no associated lyrics of the chosen song file are shown on the display 10 when the digital sounds of the chosen song file are outputted from audio output elements 2. This is because MP3 can only compress an audio file not video file. This is a significant disadvantage of the player. Further, the display 10 has not been completely utilized since only titles of the songs files are shown thereon. Thus, it is desirable to provide a karaoke typed player having audio output elements 2 for outputting digital sounds and a display 10 for displaying digital image (e.g., lyrics) of a chosen song in order to overcome the above drawback of the prior art.

### SUMMARY OF THE INVENTION

A primary object of the present invention is to provide a device of playing songs and displaying lyrics thereof and method therefor. The device includes a storage element for storing at least one song file and at least one image file matched with the song file, the song file being compressed by a compression format of a MPEG layer 3 (MP3), and a central processing unit (CPU). The method comprises the steps of activating the CPU to command a decoder to decompress the song file; outputting the song file as uncompressed digital sounds from an audio output element in the device; activating the CPU to fetch the image file matched with the song file; and outputting the image file as a digital image from a display element of the device. Hence, a user not only can hear a song playing from the device but also can see lyrics of the song shown on the display element at the same time. It is envisaged that the present invention can eliminate the drawback the well known player which only permits digital sounds of a chosen song to be given out without associated lyrics shown on the display.

The above and other objects, features and advantages of the present invention will become apparent from the following detailed description taken with the accompanying drawings.

### BRIEF DESCRIPTION OF THE DRAWINGS

FIG. 1 is a top plan view of a conventional player;

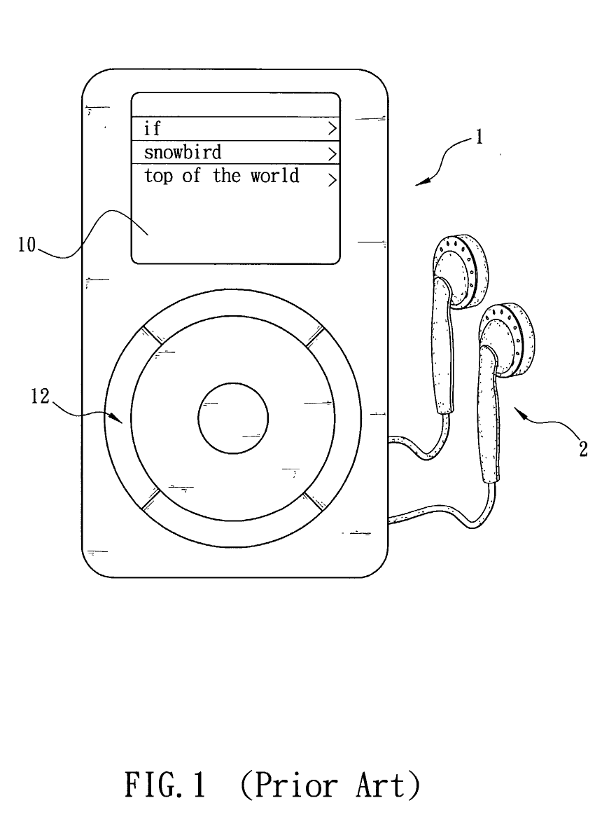

FIG. 2 is a flow chart illustrating a process for playing songs and displaying lyrics thereof according to the invention;

FIG. 3 is block diagram showing constituent components of a device of playing songs and displaying lyrics thereof according to the invention; and

FIG. 4 is a perspective view of the device.

### DETAILED DESCRIPTION OF THE PREFERRED EMBODIMENTS

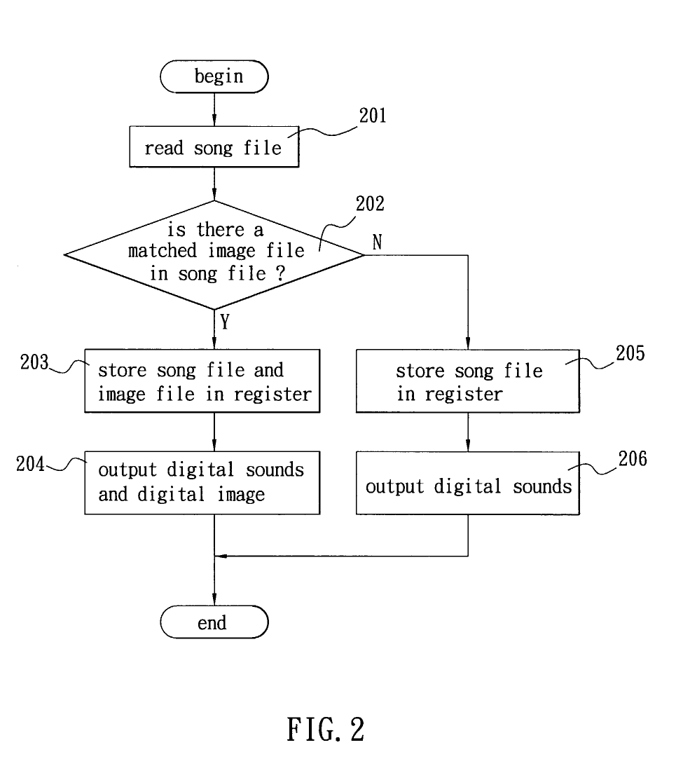

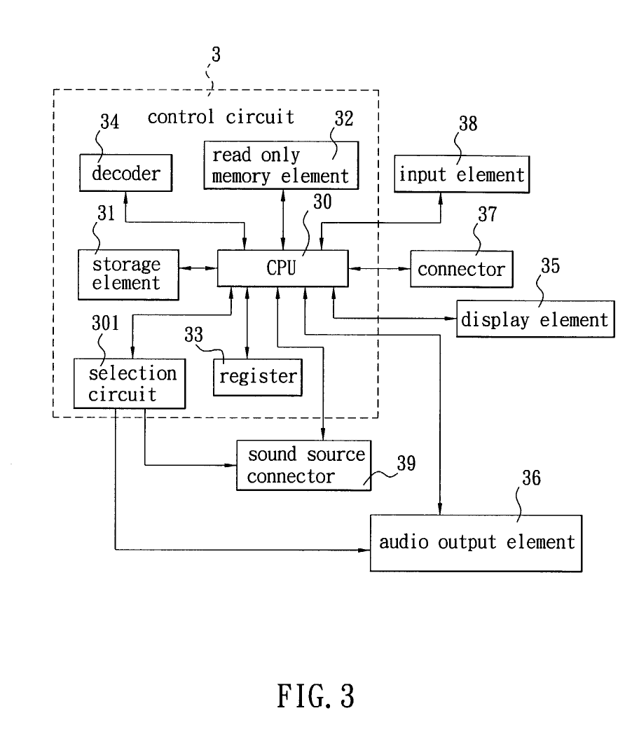

Referring to FIGS. 2 and 3, the invention is directed to a device of playing songs and displaying lyrics thereof and method therefor. The device (called player hereinafter) includes a storage element for storing at least one song file and at least one image file matched with the song file, the song file being compressed by a compression format of a MPEG layer 3 (MP3), and a central processing unit (CPU). The method comprises the steps of activating the CPU to command a decoder to decompress the song file; outputting the song file as uncompressed digital sounds from an audio output element in the player; activating the CPU to fetch the image file matched with the song file; and outputting the image file as a digital image from a display element of the player. By utilizing the invention, a user not only can hear a song playing from the player but also can see lyrics of the song shown on the display element at the same time.

In the invention, the image file comprises lyrics of a song, a plurality of output time slots corresponding to a plurality of words or phrases of the lyrics, and an index of the song. Referring to FIG. 2, the CPU can perform the following steps in response to a reading of an instruction for playing a song file.

First, read a song file (step 201). Next, a determination is made whether there is an index of the song in the image file matched with the song file (step 202). If yes, the process goes to step 203. Otherwise, the process jumps to step 205. In step 203, sequentially store the song file and a plurality of words or phrases of the lyrics in a register based on the output time slots thereof. Next, decompress the song file by means of a decoder, sequentially read the words or phrases based on the output time slots, output digital sounds from an audio output element, and output a digital image from a display element (step 204). In step 205, store the song file in the register. Finally, decompress the song file by means of the decoder and output the digital sounds from the audio output element (step 206).

In view of the above, when the audio output element of the player outputs the digital sounds, the display element can in response to the digital sounds sequentially display either a single word or a phrase by passing through the bottom of the display element similar to that of a revolving lantern. As a result, a user not only can hear a song playing from the player but also can see lyrics of the song shown on the display element thereof.

In a preferred embodiment of the invention, a play software is installed in a read only memory element of the player. The play software can generate a play signal matched with a song file. When the CPU reads the play signal outputted from the play software, the CPU can fetch a matched song file from a storage element as commanded by the play signal. Next, the CPU performs a subsequent processing based on the song file reading step.

In the preferred embodiment, the CPU can directly read the play software for fetching all song files in the storage element in response to an activation of the player. Next, the display element generates a play menu including all of the song files. A click signal is generated when one of the song files is chosen by an input element of the player. Next, the CPU reads the click signal and then performs the play software for causing the play software to generate a play signal. The play signal is then sent to the CPU. Finally, the CPU performs a subsequent processing based on the play signal reading step.

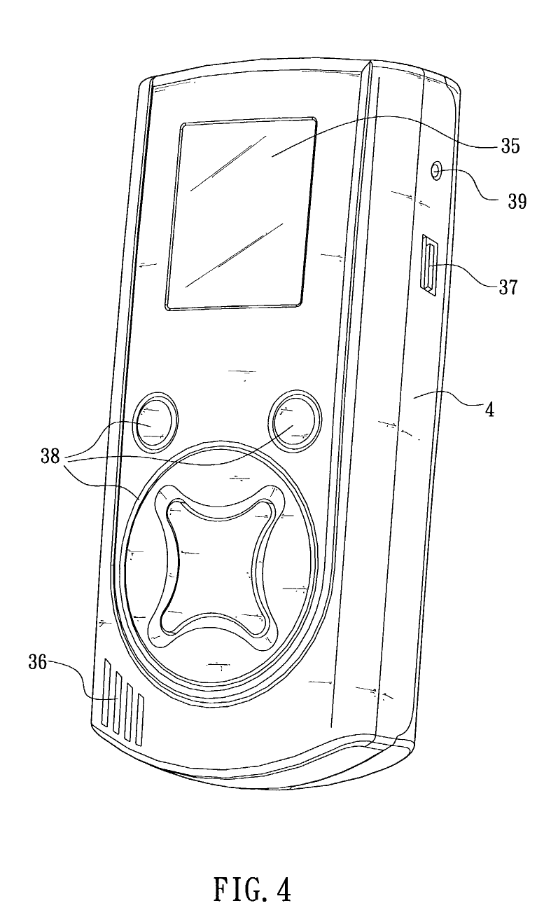

Referring to FIGS. 3 and 4, the player of the invention can output both digital sounds and a digital image at the same time. The player comprises a housing 4, a control circuit 3 in the housing 4, the control circuit 3 including a CPU 30, a storage element 31, a read only memory element 32, a register 33, and a decoder 34 in which the CPU 30 is coupled to each of the storage element 31, the read only memory element 32, the register 33, and the decoder 34, a display element 35, an audio output element 36, a connector 37, and an input element 38. The display element 35, the audio output element 36, the connector 37, and an input element 38 are disposed on the housing 4 and coupled to the CPU 30.

In the invention, the storage element 31 can store at least one song file and at least one image file. The song file is compressed by a compression format of the MP3. The image file comprises lyrics of a song, output time slots corresponding to the lyrics, and an index of the song. A play software is installed in the read only memory element 32. The register 33 can store a chosen song file and an image file matched with the song file.

In response to the activation of the player, the CPU 30 fetches all song files from the storage element 31 by performing the play software. The fetched song files are grouped as a play menu and are then shown on the display element 35. Thus, the user can choose a desired song file from the play menu by manipulating the input element 38. A click signal is generated in response to the choosing. Finally, the CPU 30 reads the click signal to generate a play signal by performing the play software.

Next, the CPU 30 fetches a matched song file from the storage element 31 as commanded by the play signal. The CPU 30 then fetches a matched index of the song based on the song file. Next, the CPU 30 stores an image file and a song file matched with the index of the song in the register 33. Subsequently, the decoder 34 decompresses the song file. Next, the audio output element 36 plays digital sounds associated with the song file. In addition, when the audio output element 36 outputs the audio signals the display element 35 can display a digital image corresponding to the image file thereon at the same time as the digital sounds are giving out. As a result, the user not only can hear a song playing from the player but also can see lyrics of the song at the same time.

Moreover, the player can be coupled to an electronic device through the connector 37 so as to download stored image files or song files from the electronic device.

Referring to FIGS. 3 and 4 again, in a preferred embodiment of the invention, a sound source connector 39 rather than the audio output element 36 is formed on the housing 4. The sound source connector 39 is connectable to another audio output element (e.g., earphone). The sound source connector 39 is coupled to the CPU 30. Hence, the CPU 30 can command the decoder 34 to decode the song file. Next, the digital sounds are sent to another audio output element for output via the sound source connector 39.

In another preferred embodiment of the invention, both the audio output element 36 and the sound source connector 39 are formed on the housing 4. A selection circuit 301 is disposed in the housing 4. The selection circuit 301 is coupled to the audio output element 36, the sound source connector 39, and the CPU 30 respectively. In response to a coupling of the sound source connector 39 and another audio output element, the selection circuit 301 may disconnect the audio output element 36 from the CPU 30 by switching. Hence, the digital sounds are only sent to another audio output element for output via the sound source connector 39. When the sound source connector 39 is disconnected from another audio output element the selection circuit 301 may disconnect the sound source connector 39 from the CPU 30 by switching. As a result, the digital sounds are only sent to the audio output element 36 for output.

By assembling the above components, when the player reads the song file digital sounds of the song file are outputted from the audio output element. At the same time, an image file matched with the song file is read. The image file is then outputted as a digital image from the display element. Thus, words associated with the song file can be shown on the display element. Hence, the user not only can hear a song playing from the player but also can see lyrics of the song shown on the display element at the same time. As such, the invention can eliminate the drawback (i.e., only digital sounds of a chosen song are given out without associated lyrics shown on the display) of the well known device capable of playing MP3 songs.

What is claimed is:

1. In a playing device including a storage element for storing at least one song file and at least one image file matched with the song file, the song file being compressed by a compression format of a Moving Picture Exports Group (MPEG) layer 3 (MP3), and a central processing unit (CPU) for processing the song file and the image file, a method for playing songs and displaying lyrics thereof comprising:
decompressing the song file by means of a decoder;
outputting the song file as uncompressed digital sounds from an audio output element in the playing device;
decompressing the song file by the decoder as commanded by the CPU and fetching the image file matched with the song file from the storage element; and
outputting the image file as a digital image from a display element of the playing device.

2. The method of claim 1, wherein the image file comprises lyrics of a song, a plurality of output time slots corresponding to the lyrics, and an index of the song so that in response to a reading of an instruction for playing the song file, the CPU is operative to perform the steps of:
reading the song file;
determining whether there is an index of the song in the image file matched with the song file and storing the song file and the lyrics of the song in a register of the playing device based on the output time slots thereof if the determination is positive; and
decompressing the song file by means of a decoder and reaindg the lyrics of the song, outputting the song file from the audio output element, and outputting the digital image from the display element at the same time.

3. The method of claim 2, wherein each of the output time slots corresponding to the lyrics is an output time slot corresponding to each word of the lyrics.

4. The method of claim 2, wherein each of the output time slots corresponding to the lyrics is an output time slot corresponding to each phrase of the lyrics.

5. The method of claim 2, further comprising the steps of storing the song file in the register and decompressing the song file by means of the decoder and outputting the song file as the digital sounds from the audio output element if the determination is negative.

6. The method of claim 1, wherein the playing device further comprises a read only memory element having an installed play software for generating a play signal matched with the song file so that in response to a reading of the play signal outputted from the play software by the CPU, the CPU is operative to fetch the matched song file from the storage element as commanded by the play signal and perform a subsequent processing based on the song file reading step.

7. The method of claim 6, wherein in response to an activation of the playing device the CPU directly reads the play software for fetching all of the song files in the storage element and command the display element to generate a play menu including all of the song files; generate a click signal when the song file is chosen by an input element of the playing device; the CPU reads the click signal and performs the play software for causing the play software to generate the play signal; send the play signal to the CPU; and the CPU performs a subsequent processing based on the reading of the play signal.

8. A device of playing songs and displaying lyrics thereof comprising:
a housing;
a control circuit disposed in the housing;
a storage element disposed on the control circuit, storage element being for storing at least one song file and at least one image file matched with the song file, the song file being compressed by a compression format of a Moving Picture Exports Group (MPEG) layer 3 (MP3), and the image file including lyrics of a song, a plurality of output time slots corresponding to the lyrics, and an index of the song;
a register disposed on the control circuit, the register being for storing the chosen song file and the image file matched with the song file;
a central processing unit (CPU) disposed on the control circuit, the CPU being coupled to the storage element and register respectively;
a read only memory element disposed on the control circuit, the read only memory element being coupled to the CPU and having an installed play software so that the CPU is capable of processing the song file and the image file in each of the storage element and the register by performing the play software;
a decoder disposed on the control circuit, the decoder being coupled to the CPU so that the CPU is capable of decompressing the song file by means of the decoder;
an input element disposed on the housing, the input element being coupled to the CPU so that in response to a receiving of an instruction about a choosing of the song file by the input element, the CPU is capable of processing the song file and the image file in each of the storage element and the register;
a display element disposed on a side of the housing, the display element being coupled to the CPU, the display element being capable of showing a digital image corresponding to the song file chosen by the input element as the play software is performed;
an audio output element disposed on the housing being coupled to the CPU, the audio output element being capable of outputting digital sounds generated by uncompressing the song file as the play software is performed; and
a connector disposed on the housing, the connector being interconnected between the CPU and an electronic means for downloading image files or song files stored in the electronic means.

9. The device of claim 8, wherein the input element is disposed on the same side as the display element on the housing.

10. The device of claim 8, further comprising a sound source connector disposed on the housing in lieu of the audio output element, the sound source connector being connectable to a second audio output element and coupled to the CPU.

11. The device of claim 8, further comprising a sound source connector disposed on the housing and a selection circuit disposed in the housing, the selection circuit being coupled to the audio output element, the sound source connector, and the CPU respectively.
